(19) United States
(12) Patent Application Publication
(10) Pub. No.: US 2022/0126554 A1
(43) Pub. Date: Apr. 28, 2022

(54) METHOD FOR LAMINATING A PROTECTIVE SCREEN ONTO A FLEXIBLE DISPLAY SUPPORT AND MATRIX INTENDED FOR THE IMPLEMENTATION OF SAID LAMINATION METHOD

(71) Applicant: NOVARES FRANCE, Clamart (FR)

(72) Inventors: Louis ASENSIO, Menton (FR); Marcel VANNI, Nice (FR)

(21) Appl. No.: 17/428,514

(22) PCT Filed: Jan. 31, 2020
(86) PCT No.: PCT/FR2020/050161

§ 371 Date: Aug. 4, 2021

(30) Foreign Application Priority Data
Feb. 5, 2019 (FR) 19/01118

(51) Int. Cl. B32B 37/00; B32B 37/12; B32B 38/18; B32B 17/06; B32B 27/06

(52) U.S. Cl. CPC B32B 37/003; B32B 37/12; B32B 38/1858; B32B 2457/20; B32B 37/0046; B32B 17/06; B32B 27/06; B32B 38/1866

(57) ABSTRACT

A method for laminating a protective screen onto a flexible display support, notably an electronic tile, includes the following steps bringing a protective screen and a display support progressively into contact by using an elastically deformable punch until a maximum area of contact between the protective screen and the display support is achieved in a configuration in which the assembly formed by the protective screen and the display support is fully laminated. The external surface of the punch has a three-dimensional shape substantially equal to that of the display support.

### TECHNICAL FIELD

The present disclosure concerns a method for laminating a protective screen on a flexible display support, in particular an electronic panel. The disclosure also concerns a matrix intended for the implementation of such a laminating method, as well as a trim panel for the passenger compartment of a motor vehicle equipped with a three-dimensional display panel obtained by said method.

### BACKGROUND

In the automotive field, luminous display panels intended to be integrated into the passenger compartment of the vehicle are increasingly used. These display panels can in particular consist of an electronic panel integrated into the cabinetry of the vehicle and allowing the transmission of luminous information to the attention of the driver or passengers by means of a display of the LED, LCD or OLCD type for example. This electronic panel may have for example an interface in electronic communication with the on-board computer of the vehicle so as to be able to display information relating to the vehicle itself, such as its speed for example, or relating to the external environment, such as the outside temperature. This electronic panel is often covered by a transparent or translucent protective screen so as to prevent premature deterioration of the panel due to impacts or contacts that may occur during use of the vehicle. This protective screen is generally formed of glass or plastic.

Currently, this type of display panel is generally flat or two-dimensional and is formed by laminating the protective screen onto the panel by vacuum or roller application methods. Nonetheless, these application methods prove to be unsuitable when the display panel is not flat or in two dimensions. In fact, during the laminating method, air bubbles are generally found trapped between the screen and the panel due to the curvatures and reliefs of the panel and of the screen. These air bubbles can cause light scattering that alters the light path, resulting in a degraded display at the areas where the air bubbles are created. The display panel is therefore not entirely satisfactory.

### SUMMARY

One of the aims of the disclosure is to overcome this drawback by proposing a laminating method that avoids the trapping of air bubbles between the protective screen and the electronic panel.

To this end, the disclosure concerns a method for laminating a protective screen on a flexible display support, in particular an electronic panel, comprising the steps of:

a) Providing a transparent or translucent protective screen having a curved three-dimensional shape;

b) Providing a flexible display support having a curved three-dimensional shape substantially identical to that of the protective screen and, preferably, covered at least partially by a film of adhesive;

c) Positioning and fixing the protective screen on a lower portion of the matrix;

d) Positioning and fixing the display support on an upper portion of the matrix equipped with an elastically deformable punch, said display support being positioned so that it rests on a curved outer surface of said punch, said outer surface having then a three-dimensional shape slightly different from that of the display support;

e) Optionally, depositing glue on the display support in the case where the display support is not already covered with a film of glue;

f) Assembling the upper portion of the matrix on the lower portion of the matrix so as to form a matrix, in which the protective screen and the display support are not in contact with each other initially and such that the upper portion of the matrix is able to move closer to the lower portion of the matrix under the effect of a downward pressure exerted on the upper portion of the matrix;

g) Bringing together the lower and upper portions of the matrix until at least one point contact is created between the protective screen and the display support;

h) Gradually bringing together the lower and upper portions of the matrix so that the contact surface between the protective screen and the display support gradually increases until a maximum value is reached corresponding to a fully laminated configuration of the assembly formed by the protective screen and the display support, the outer surface of the punch then having a substantially identical three-dimensional shape to that of the display support.

The method of the disclosure may also comprise one or more of the following characteristics:
the punch is formed at least partially, and preferably entirely, in an elastomeric material.
the punch is formed from two portions, namely an outer portion on which the display support rests and an inner portion contiguous to the outer portion, the outer portion having a compressibility coefficient lower than the inner portion.
the punch rests on springs disposed inside the upper portion of the matrix so that the punch can be displaced upwards in steps g) and h).
that the punch rests on an inflatable structure disposed inside the upper portion of the matrix so that the position of the punch can vary according to the volume of air contained in the inflatable structure.
the protective screen is formed by injection of a plastic material.
the plastic material is preferably selected from polyamide, poly-methyl methacrylate and polycarbonate.
the protective screen is made of glass.
the bringing together of the lower and upper portions of the matrix in steps g) and h) takes place by means of a press inside which the matrix formed by the assembly of the lower and upper portions is placed.
the method comprises an intermediate step g′) carried out before step g) comprising bringing the punch to temperature so as to activate the glue covering the display support.

The disclosure also concerns a matrix intended for implementing the laminating method as described above, comprising:
a lower portion intended to receive a protective screen,
an upper portion equipped with an elastically deformable punch, said lower and upper portions being assembled together so as to be able to be displaced relative to each other along a displacement direction,
guide means suitable for ensuring the guiding of the upper portion and/or the lower portion in translation along said displacement direction,
damping means disposed between the lower portion and the upper portion, said damping means being intended to keep said lower and upper portions at a distance.

The matrix of the disclosure may also comprise one or more of the following characteristics:
the lower portion is shaped so as to define a housing having a three-dimensional shape complementary to that of the protective screen.
the punch is provided with fixing means suitable for ensuring the positioning and maintaining of a flexible display support, in particular an electronic panel, on the upper portion.
the fixing means are of the mechanical type, in particular comprise one or more clips.
the fixing means are of the pneumatic type, in particular are capable of creating a vacuum under the display support.
the guide means comprise a plurality of columns secured to the lower portion and along which the upper portion can slide.
the damping means are constituted by compression springs.

The disclosure also concerns a trim panel for the passenger compartment of a motor vehicle equipped with a three-dimensional display panel obtained by the lamination method as described above.

### BRIEF DESCRIPTION OF THE DRAWINGS

Other aspects and advantages of the disclosure will become apparent on reading the description which follows, given by way of example and made with reference to the appended drawings, in which:

FIG. 1 is a perspective view of a trim panel of a motor vehicle passenger compartment equipped with a three-dimensional display panel obtained by the method of the disclosure;

FIG. 2 is a perspective view of a protective screen that can be used for implementing the method of the disclosure;

FIG. 3 is a perspective view of a flexible display support used for implementing the method of the disclosure;

FIG. 4 is a perspective view of a lower portion of a matrix that can be used for implementing the method of the disclosure;

FIG. 5 is a perspective view of an upper portion of a matrix which can be used for implementing the method of the disclosure;

FIG. 6 is a perspective view of the respective positions of the lower and upper portions represented in FIGS. 4 and 5 at the time of their assembly;

FIG. 7 is a perspective view of the matrix represented in FIG. 6 just before going to press;

FIG. 8a shows the relative positions between the protective screen, the display support and the punch at the start of the approximation between the upper portion of the matrix and the lower portion of the matrix;

FIG. 8b shows the relative positions between the protective screen, the display support and the punch in an intermediate phase of approximation between the upper portion of the matrix and the lower portion of the matrix;

FIG. 8c shows the relative positions between the protective screen, the display support and the punch at the end of the approximation between the upper portion of the matrix and the lower portion of the matrix;

FIG. 9a is a perspective view of a first punch configuration that can be used for implementing the method of the disclosure;

FIG. 9b is a perspective view of a second punch configuration that can be used for implementing the method of the disclosure;

FIG. 9c is a perspective view of a third punch configuration that can be used for implementing the method of the disclosure;

FIG. 10a is a bottom view of the display support showing the progress of a central contact zone;

FIG. 10b is a view similar to FIG. 10a in the case of a progression of the contact zone from one of the lateral edges; and

FIG. 11 is a simplified diagram of the various steps of the method of the disclosure.

### DETAILED DESCRIPTION OF THE DRAWINGS

In the description, the term «outer» denotes what is visible from the passenger compartment of the motor vehicle or which is directed towards the interior of the passenger compartment and the term «inner» denotes what is not visible from the passenger compartment or which is directed outside the passenger compartment. Furthermore, the term «longitudinal» is defined according to the largest dimension of a trim panel and the term «lateral» is defined in a direction perpendicular to the longitudinal direction.

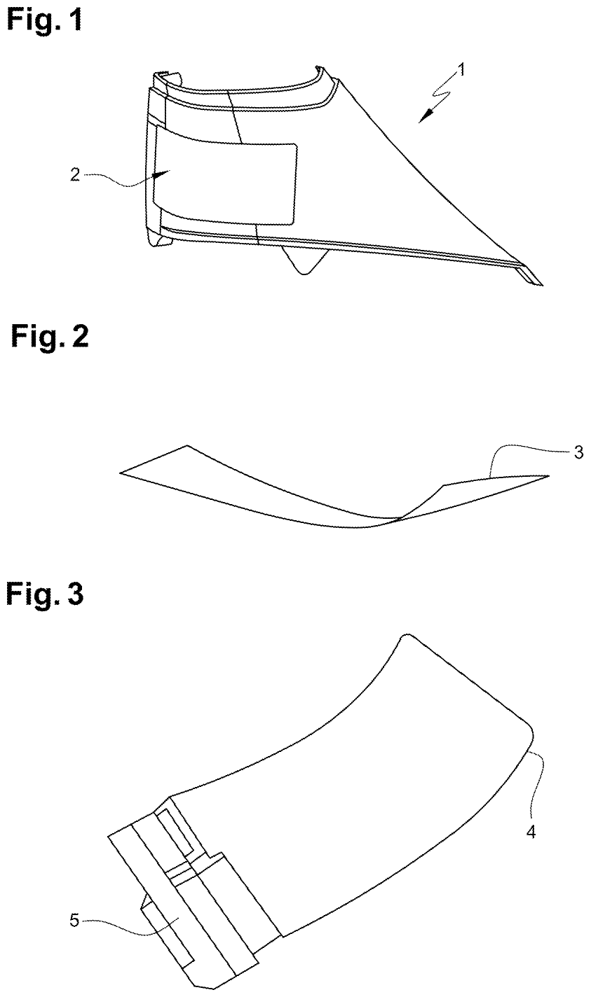

With reference to FIG. 1, there is represented a trim panel 1 of a motor vehicle comprising a display panel 2 intended to deliver luminous messages to the driver or to the passengers of the vehicle. This display panel 2 is located on a curved edge of the trim panel 1. It therefore has a non-flat three-dimensional profile. As represented in FIGS. 2 and 3, this display panel 2 is formed, on the one hand, of a flexible display support 4, of the electronic panel type, and, on the other hand, of a transparent protective screen 3 which is laminated on the outer face of the display support 4. The protective screen 3 may have substantially the same dimensions as the display support 4, as in the represented example, or larger dimensions. In particular, as represented in FIGS. 8a to 8c, the protective screen 3 can also cover the entire outer surface of the trim panel 1. This protective screen 3 will in particular be formed of glass or of injected plastic, in particular of polyamide (PA), poly-methyl methacrylate (PMMA) or polycarbonate (PC) or other translucent plastic material. As represented in FIG. 5, the display support 4 of the electronic panel type is equipped with a connection interface 5 intended to be wired, for example, to the on-board computer of the motor vehicle so as to receive electronic signals coming from said computer or to a camera located outside the vehicle. Depending on the received electronic signals, the display support 4 will thus deliver a specific luminous message which will be visible from the passenger compartment of the vehicle. In an advantageous configuration, the display support 4 may advantageously be covered on its outer face with an adhesive layer so as to allow the protection screen 3 to be attached. This adhesive layer may in particular comprise a film of transparent optical adhesive, of the OCA type, integrated into the display support 4 and protected by a protective sheet, the protective sheet being intended to be removed during lamination. In the absence of this adhesive film, an additional step will be provided in the lamination method comprising the step of depositing a transparent optical adhesive layer on the outer face of the display support 4, prior to contacting the protective screen 3 and the display support 4.

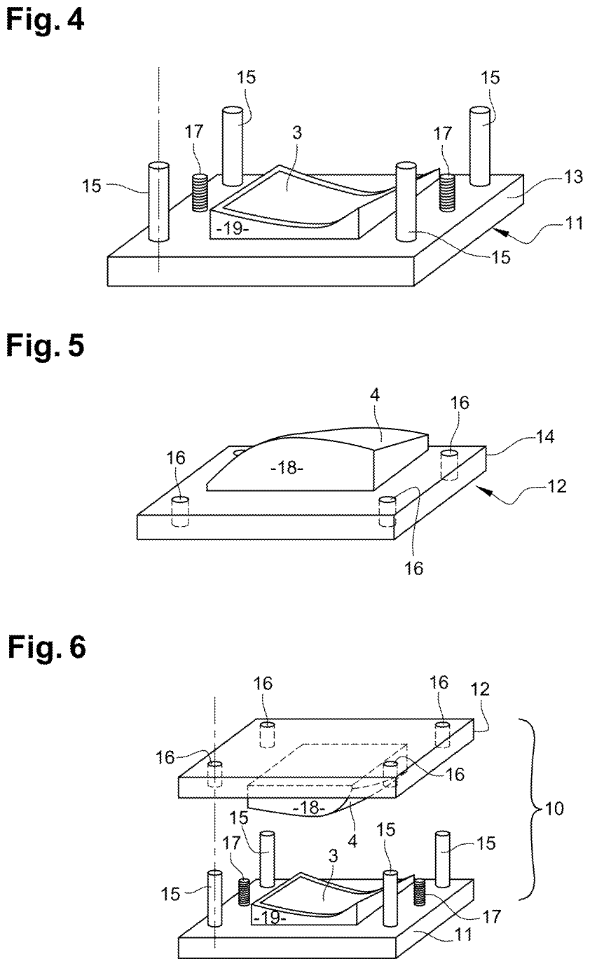

With reference to FIG. 4, there is represented a lower portion 11 of the matrix on which is fixed the protective screen 3. This lower portion 11 of the matrix comprises in particular a support plate 13 of substantially rectangular shape on the upper surface of which protrudes, on the one hand, a double pair of columns 15 disposed respectively near each top of the support plate 13, and, on the other hand, a reception platform 19 intended to receive the protective screen 3. The reception platform 19 has in particular a shape complementary to that of the protective screen 3. The protective screen 3 will be fixed on said reception platform 19 either mechanically, by means of one or more clips for example, or pneumatically, by creating in particular a vacuum under the protective screen 3. The support plate 13 is also provided with a pair of receiving holes inside which is housed damping means 17 of the compression spring type, said springs protruding from the upper surface of the support plate 13. The role of the damping means 17 will be explained in more detail in the following paragraphs.

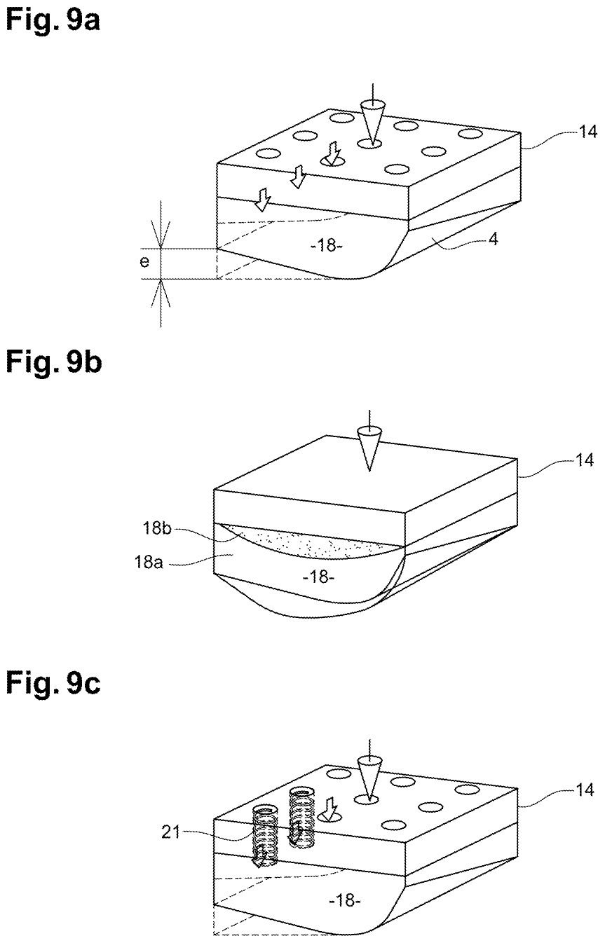

With reference to FIG. 5, there is represented an upper portion 12 of the matrix on which is fixed the display support 4. This upper portion 12 of the matrix comprises in particular a support plate 14 of substantially rectangular shape on the upper surface of which protrudes a punch 18 on which the display support 4 rests. The punch 18 is advantageously formed in an elastically deformable material so that its outer shape can vary depending on the pressure exerted on said outer face. When not subjected to any pressure, the shape of the punch 18 will be slightly different from that of the display support 4, so that a gap e may exist between the punch 18 and the display support 4 on some zones of the punch 18 (see FIG. 9a for example). In the configuration of FIGS. 5 and 9a, the punch 18 is formed from a single elastomeric material, such as rubber or silicone, said material having a high compressibility coefficient. In another configuration, represented in FIG. 9b, the punch 18 may be formed of two portions, namely an outer portion 18a on which the display support 4 rests and an inner portion 18b contiguous to the outer portion 18a, the outer portion 18a having a lower compressibility coefficient than the inner portion 18b. In another possible configuration, represented in FIG. 9c, the punch 18 can rest on springs 21 disposed inside the support plate 14 of the upper portion 12 of the matrix so that the punch 18 can move upwards during the contact between the protective screen 3 and the display support 4. These springs 21 can be made of metal or of plastic. In another possible configuration, not represented, these springs 21 will be replaced by an inflatable structure placed inside the support plate 14.

The display support 4 will be fixed on the punch 18 either mechanically, by means of one or more clips for example, or pneumatically, in particular by creating a vacuum under the display support 4. Furthermore, the support plate 14 is also provided with two pairs of through holes 16 positioned respectively near each top of the support plate 14. These through holes 16 are intended to receive the columns 15 of the lower portion 11 of the matrix during the assembly of the lower 11 and upper 12 portions of the matrix.

With reference to FIG. 6, there is represented the respective positions of the lower 11 and upper 12 portions of the matrix at the time of their assembly. The upper portion 12 of the matrix has thus been rotated on itself 180° so that the punch 18 is directed downwards towards the reception platform 19. The through holes 16 are aligned with the columns 15. Subsequently, the support plate 12 is lowered in the direction of the support plate 11 until it comes into contact with the damping means 17. These damping means 17 thus make it possible to maintain a certain distance between the punch 18 and the reception platform 19. Thus assembled, the lower 11 and upper 12 portions of the matrix form a matrix 10.

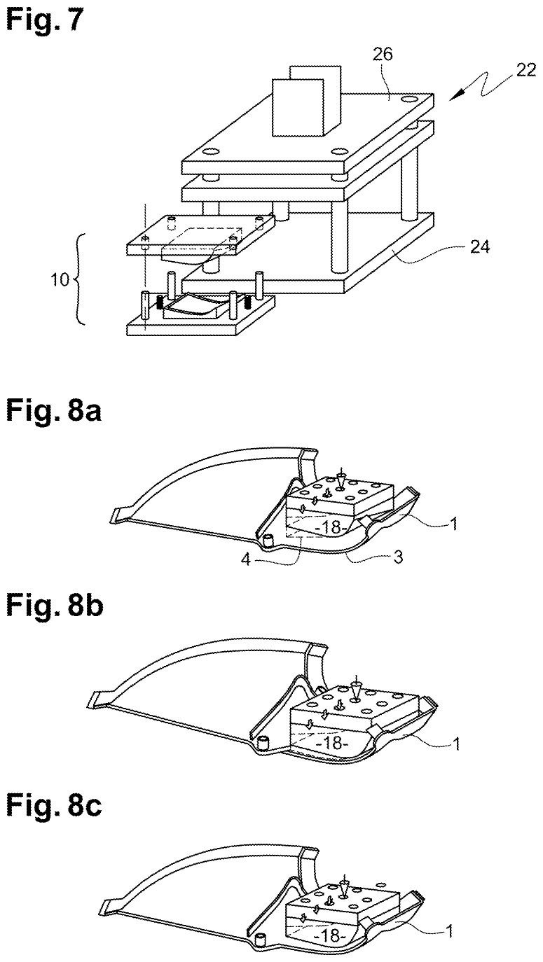

With reference to FIG. 7, there is represented the matrix 10 just before it is placed under a press 22. The press 22 includes in particular a lower plate 24 and an upper plate 26 between which the matrix 10 is positioned, said lower 24 and upper 26 plates being able to move closer to one another under the action of displacement means (not represented). While moved closer, the plates 24 and 26 exert a vertical pressure on the lower 11 and upper 12 portions of the matrix 10 which tends to bring them closer to one another. This approximation is advantageously done gradually as illustrated in FIGS. 8a to 8c.

With reference to FIG. 8a, there is represented the relative positions between the protective screen 3, the display support 4 and the punch 18 at the start of the approximation between the upper portion 12 of the matrix 10 and the lower portion 11 of the matrix 10. It should be noted that, in the represented configuration, the protective screen 3 is an integral part of the trim panel 1. During this initial phase, the display support 4 is not yet in contact with the protective screen 3. As represented in an enlarged manner in FIG. 9a, the punch 18 is still in its initial undeformed state. The protective screen 3 does not completely match the outer surface of the punch 18 so that a vertical gap e is created between one of the lateral edges of the display support 4 and the outer surface of the punch 18, the distance between the display support 4 and said outer surface then gradually reducing along a longitudinal direction.

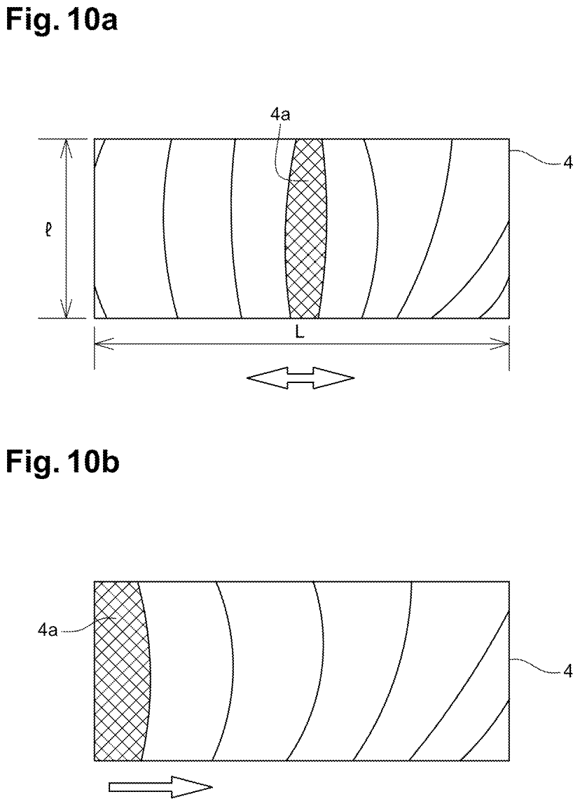

With reference to FIG. 8b, there is represented the relative positions between the protective screen 3, the display support 4 and the punch 18 in an intermediate phase of bringing closer the upper portion 12 of the matrix 10 and the lower portion 11 of the matrix 10. In this intermediate phase, the display support 4 has come into contact with the protective screen 3 at the level of a contact zone 4a extending over a small central portion of the length L of the display support 4 and over its entire width I, as illustrated in FIG. 10a. According to a possible variant, illustrated in FIG. 10b, this contact zone 4a could also be positioned on one of the lateral edges of the display support 4. According to another non-represented possible variant, this contact zone 4a could be limited substantially to one point. At this contact zone 4a, a deformation of the outer surface of the punch 18 has occurred so as to allow a uniform and homogeneous adhesion of the protective screen 3 on the display support 4 and thus prevent the formation of intermediate air bubbles. Subsequently, the approximation of the portions 11 and 12 of the matrix 10 continuing in a progressive manner, this contact zone 4a has extended in the longitudinal direction or in the direction of the two lateral edges of the display support 4, in the variant represented in FIG. 10a, either in the direction of the opposite lateral edge, in the variant represented in FIG. 10b. During this gradual approximation, the outer surface of the punch 18 is progressively deformed so as to gradually conform to the outer contour of the display support 4. This progressive deformation thus makes it possible to avoid the formation of intermediate air bubbles during the lamination of the protective screen 3 on the display support 4.

With reference to FIG. 8c, there is represented the relative positions between the protective screen 3, the display support 4 and the punch 18 at the end of the approximation between the upper portion 12 of the matrix 10 and the lower portion 11 of the matrix 10. In this final phase, the display support 4 is completely in contact with the protective screen 3, the contact zone 4a covering the entire surface of the display support 4. The outer surface of the punch 18 then has a three-dimensional shape substantially identical to that of the display support 4.

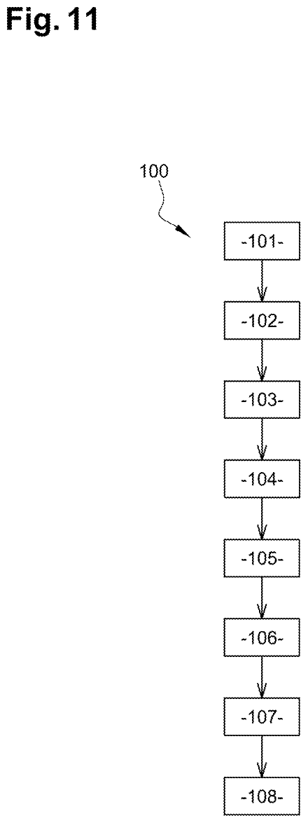

With reference to FIG. 11, there is represented in a block diagram the different steps of the laminating method 100 according to the disclosure.

In the first step 101, a transparent or translucent protective screen is provided and formed either in a plastic material or in a glass material.

In a second step 102, a flexible display support is provided having a curved three-dimensional shape substantially identical to that of the protective screen and, preferably, covered at least partially by a film of adhesive.

In a third step 103, the protective screen is positioned and fixed on a lower portion of the matrix.

In a fourth step 104, the display support is positioned and fixed on an upper portion of the matrix equipped with an elastically deformable punch, said display support being positioned so that it rests on a curved outer surface of said punch, said outer surface then having a three-dimensional shape slightly different from that of the display support.

In a fifth optional step 105, a film of glue is deposited on the display support if the latter is not already covered with a film of glue.

In a sixth step 106, the upper portion of the matrix is assembled on the lower portion of the matrix so as to form a matrix, in which the protective screen and the display support are not in contact with each other at the start and so that the upper portion of the matrix is able to move closer to the lower portion of the matrix under the effect of a downward pressure exerted on the upper portion of the matrix.

In a seventh step 107, the lower and upper portions of the matrix are brought closer until at least one point contact is created between the protective screen and the display support.

In an eighth step 108, the lower and upper portions of the matrix are gradually brought closer so that the contact surface between the protective screen and the display support progressively increases until a maximum value corresponding to a fully laminated configuration of the assembly formed by the protective screen and the display support is reached, the outer surface of the punch then having a three-dimensional shape substantially identical to that of the display support.

Other additional steps may be provided in addition to the steps mentioned above. In particular, provision may be made for an intermediate step carried out before the step 107 comprising bringing the punch to temperature so as to activate the glue covering the display support.

1. A method for laminating a protective screen on a flexible display support, the method including the following steps:
a) providing a transparent or translucent protective screen having a curved three-dimensional shape;
b) providing a flexible display support having a curved three-dimensional shape substantially identical to that of the protective screen and covered at least partially by a film of glue;
c) positioning and fixing the protective screen on a lower portion of the matrix;
d) positioning and fixing the display support on an upper part of the matrix equipped with an elastically deformable punch, said display support being positioned so that said display support rests on a curved outer surface of said punch, said outer surface then having a three-dimensional shape slightly different from that of the display support;
e) optionally, depositing glue on the display support in the case where the display support is not already covered with a film of glue;
f) assembling the upper portion of the matrix on the lower portion of the matrix so as to form a matrix, in which the protective screen and the display support are not in contact with each other at the start and so that the upper portion of the matrix is able to come closer to the lower portion of the matrix under the effect of downward pressure on the upper portion of the matrix;
g) bringing together the lower and upper portions of the matrix until at least one point contact is created between the protective screen and the display support; and
h) gradually bringing closer the lower and upper portions of the matrix so that the contact surface between the protective screen and the display support gradually increases until a maximum value is reached corresponding to a fully laminated configuration of the assembly formed by the protective screen and the display support, the outer surface of the punch then having a three-dimensional shape substantially identical to that of the display support.

2. The method according to claim 1, wherein the punch is at least partially, formed in an elastomeric material.

3. The method according to claim 1, wherein the punch is formed of two portions, outer portion on which rests the display support and an inner portion adjacent to the outer portion, the outer portion having a compressibility coefficient lower than the inner portion.

4. The method according to claim 1, wherein the punch rests on springs disposed inside the upper portion of the matrix so that the punch can be displaced upwards in steps g) and h).

5. The method according to claim 1, wherein the punch rests on an inflatable structure disposed inside the upper portion of the matrix so that the position of the punch may vary depending on the volume of air contained in the inflatable structure.

6. The method according to claim 1, wherein the protective screen is formed by injection of a plastic material.

7. The method according to claim 6, wherein the plastic material is selected from the group consisting of polyamide, poly(methyl) methacrylate, and polycarbonate.

8. The method according to claim 1, wherein the protective screen is formed of glass.

9. The method according to claim 1, wherein the approximation of the lower and upper portions of the matrix fin steps g) and h) takes place using a press inside which is placed the matrix formed by the assembly of the lower and upper portions.

10. The method according to claim 1, wherein the method further includes an intermediate step g′) carried out before step g) including bringing the punch to temperature so as to activate the glue covering the display support.

11. A matrix intended for implementing the laminating method of claim 1, said matrix comprising:
a lower portion intended to receive a protective screen,
an upper portion equipped with an elastically deformable punch, said lower and upper portions being assembled together so as to be able to be displaced relative to each other along a displacement direction,
guide means capable of ensuring the translational guidance of the upper portion and/or lower portion along said displacement direction, and
damping means disposed between the lower portion and the upper portion, said damping means being intended to maintain said lower and upper portions at a distance.

12. The matrix according to claim 11, wherein the lower portion is shaped so as to define a housing having a three-dimensional shape complementary to that of the protective screen.

13. The matrix according to claim 11, wherein the punch is provided with fixing means suitable for positioning and maintaining a flexible display support, on the upper portion.

14. The matrix according to claim 13, wherein the fixing means are of the mechanical type, and comprises one or more clips.

15. The matrix according to claim 13, wherein the fixing means are of the pneumatic type, and are capable of creating a vacuum under the display support.

16. The matrix according to claim 11, wherein the guide means comprise a plurality of columns secured to the lower portion and along which the upper portion can slide.

17. The matrix according to claim 11, wherein the damping means are constituted by compression springs.

18. A trim panel for a motor vehicle passenger compartment equipped with a three-dimensional display panel obtained by the method according to claim 1.
